(19) United States
(12) Patent Application Publication
(10) Pub. No.: US 2014/0110087 A1
(43) Pub. Date: Apr. 24, 2014

(54) GRAVITY LOOP HEAT PIPE HEAT SINK, CONDENSER, AND PRODUCTION METHODS THEREOF

(71) Applicant: Huawei Technologies Co., Ltd., Shenzhen (CN)

(72) Inventors: Hongliang Chen, Shenzhen (CN); Bin Wang, Shenzhen (CN); Naier Meng, Shenzhen (CN)

(73) Assignee: Huawei Technologies Co., Ltd., Shenzhen (CN)

(21) Appl. No.: 14/089,527

(22) Filed: Nov. 25, 2013

Related U.S. Application Data
(63) Continuation of application No. PCT/CN2012/080534, filed on Aug. 24, 2012.

(30) Foreign Application Priority Data
Jan. 5, 2012 (CN) 201210002231.7

(51) Int. Cl. B23P 15/26; F28D 15/02

(52) U.S. Cl. CPC B23P 15/26; F28D 15/02
USPC 165/104.21; 29/890.07; 29/890.032

(57) ABSTRACT

A condenser in a gravity loop heat pipe heat sink and a method for producing the condenser are disclosed. The production method includes the following steps: squeezing a base material of a condenser to form a condenser substrate and several longitudinal channels of the condenser, where the longitudinal channels of the condenser are parallel to and thread through the condenser substrate; drilling holes at the two ends of the condenser substrate to form transverse channels of the condenser, where the transverse channels of the condenser are connected to the longitudinal channels of the condenser; and sealing ends of the longitudinal channels of the condenser and ends of the transverse channels of the condenser according to determined holes on the condenser that are connected to the outside.

### CROSS-REFERENCE TO RELATED APPLICATIONS

This application is a continuation of International Application No. PCT/CN2012/080534, filed on Aug. 24, 2012, which claims priority to Chinese Patent Application No. 201210002231.7, filed on Jan. 5, 2012, both of which are hereby incorporated by reference in their entireties.

### TECHNICAL FIELD

The present invention relates to the field of heat exchange technologies, and in particular to a condenser in a gravity loop heat pipe heat sink and a method for producing the condenser. The present invention further relates to a gravity loop heat pipe heat sink and a method for producing the gravity loop heat pipe heat sink.

### BACKGROUND

A gravity loop heat pipe heat sink (such as Loop Thermosyphon, LTS) is a two-phase phase-change heat sink. Refer to FIG. 1. FIG. 1 is a schematic diagram of working principles of a heat sink in the prior art.

The heat sink mainly consists of four parts: an evaporator substrate 20, a condenser 10, a vapor rising pipeline 30, and a liquid return pipeline 40.

The evaporator substrate 20 has longitudinal pipelines 203. A transverse liquid gathering pipeline 202 exists at a lower end of the evaporator substrate 20, and a transverse vapor gathering pipeline 201 exists at an upper end of the evaporator substrate 20. The condenser 10 has longitudinal pipelines 103. A transverse vapor gathering pipeline 101 exists at an upper end of the condenser 10, and a longitudinal liquid gathering pipeline 102 exists at a lower end of the condenser 10. The vapor gathering pipeline 201 at the upper end of the evaporator 20 is connected through the vapor rising pipeline 30 on the left side to the vapor gathering pipeline 101 at the upper end of the condenser 10. The liquid gathering pipeline 102 at the lower end of the condenser 10 is connected through the liquid return pipeline 40 on the right side to the liquid gathering pipeline 202 at the lower end of the evaporator 20.

The working principles of the heat sink are as follows: The evaporator substrate 20 contacts a heat source (such as a wireless radio frequency module), and absorbs heat of the heat source; a liquid working medium (in the liquid gathering pipeline 202 and the longitudinal pipelines 203) inside the evaporator substrate 20 evaporates after being heated; generated vapor reaches, after passing the vapor gathering pipeline 201 and the vapor rising pipeline 30, the vapor gathering pipeline 101 at the upper end of the condenser 10; then the vapor goes downward along the longitudinal pipelines 103 of the condenser 10, and exchanges heat with air around the longitudinal pipelines 103 so as to achieve condensation and heat dissipation; when reaching the liquid gathering pipeline 102 at the lower end of the condenser 10, the vapor completely condenses into liquid; and finally, the vapor flows back through the liquid return pipeline 40 to the liquid gathering pipeline 202 of the evaporator substrate 20 to finish a cycle.

In the prior art, a main body of the condenser 10 is mainly made up of several pipes, and the pipes form the longitudinal pipelines 103. The two ends of each pipe are respectively connected in a welding manner to the vapor gathering pipeline 101 and the liquid gathering pipeline 102. Therefore, there are excessive welding joints between the pipes of the condenser 10 and the vapor gathering pipeline 101 or the liquid gathering pipeline 102. This causes relatively difficult manufacturing and relatively high manufacturing costs, and consistency can hardly be ensured during production and manufacturing. In addition, the excessive welding joints also affect sealing performance, device strength, or the like, of the condenser 10, and further affect operating reliability of the condenser 10.

### SUMMARY

The present disclosure provides a condenser in a gravity loop heat pipe heat sink and a method for producing the condenser, so as to resolve the following problem with the prior art: Operating reliability is relatively low due to excessive welding joints for connecting a longitudinal channel of a condenser to a transverse channel of the condenser. The method for producing the condenser enables the longitudinal channel of the condenser and the transverse channel of the condenser to be integrated without requiring welding, and operating reliability of the condenser manufactured by using the production method is relatively high. Another objective of the present invention is to provide a gravity loop heat pipe heat sink and a method for producing the gravity loop heat pipe heat sink.

The present disclosure provides a method for producing a condenser in a gravity loop heat pipe heat sink. The method includes the following steps:

squeezing a base material of a condenser to form a condenser substrate and several longitudinal channels of the condenser, where the longitudinal channels of the condenser are parallel to and thread through the condenser substrate, and the longitudinal channels of the condenser are configured to condense vapor;

drilling holes at the two ends of the condenser substrate to form transverse channels of the condenser that are connected to the longitudinal channels of the condenser, where the transverse channels of the condenser at the two ends respectively support circulation of vapor and liquid that is formed after vapor is condensed; and

sealing ends of the longitudinal channels of the condenser and ends of the transverse channels of the condenser according to determined holes on the condenser that are connected to the outside.

In the method for producing a condenser in a gravity loop heat pipe heat sink according to the embodiments of the present invention, longitudinal channels of the condenser are formed by using a squeezing technology, and transverse channels of the condenser are formed on a substrate by using a drilling method. That is, the longitudinal channels of the condenser and the transverse channels of the condenser are formed on the substrate by using the squeezing and drilling methods. Therefore, the longitudinal channels of the condenser and the transverse channels of the condenser are integrated and do not need to be connected in a welding manner. Therefore, no welding joints exist between the longitudinal channels and the transverse channels of the condenser formed by using this production method, so that sealing performance, strength, or the like, of the condenser can be ensured and the condenser formed by using this production method has relatively high operating reliability.

### BRIEF DESCRIPTION OF DRAWINGS

FIG. 1 is a schematic diagram of working principles of a gravity loop heat pipe heat sink in the prior art;

FIG. 2 is a schematic structural diagram of a gravity loop heat pipe heat sink according to a specific embodiment of the present invention;

FIG. 3 is a schematic structural diagram of a condenser shown in FIG. 2;

FIG. 4 is a side view of the condenser shown in FIG. 3;

FIG. 5 is a flowchart of a method for producing a condenser in a gravity loop heat pipe heat sink according to a specific embodiment of the present invention; and

FIG. 6 is a flowchart of a method for producing a condenser in a gravity loop heat pipe heat sink according to another specific embodiment of the present invention.

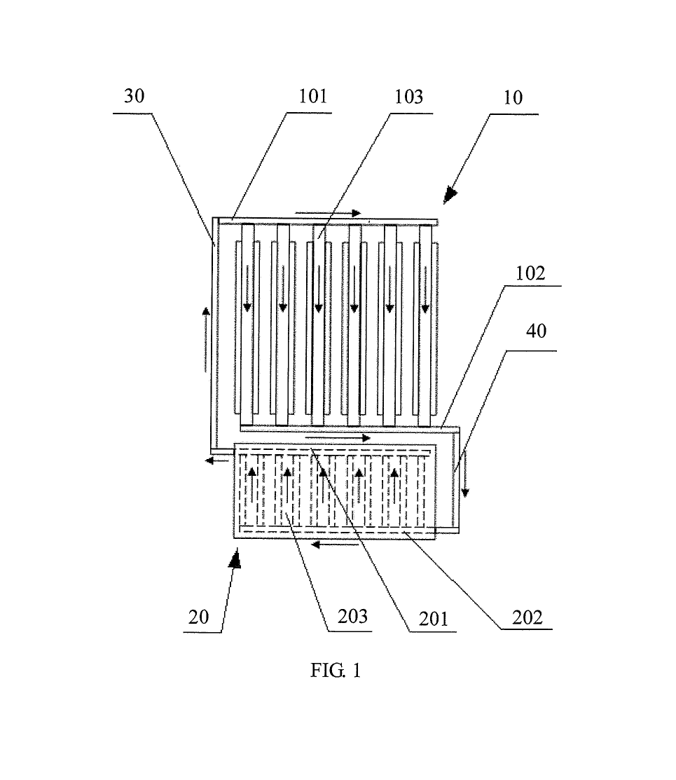

### DESCRIPTION OF EMBODIMENTS

One core of the present invention is to provide a condenser in a gravity loop heat pipe heat sink and a method for producing the condenser. The method for producing the condenser enables a longitudinal channel of the condenser and a transverse channel of the condenser to be integrated without requiring welding, and operating reliability of the condenser manufactured by using the production method is relatively high. Another core of the present invention is to provide a gravity loop heat pipe heat sink and a method for producing the gravity loop heat pipe heat sink.

To help a person of ordinary skill in the art to better understand the technical solutions of the present invention, the following further describes in detail the present invention with reference to the accompanying drawings and specific embodiments. For ease of understanding and simplicity of discussion, the following describes the condenser in combination with overall structure of the gravity loop heat pipe heat sink and production methods thereof, and no further details about beneficial effects are provided herein.

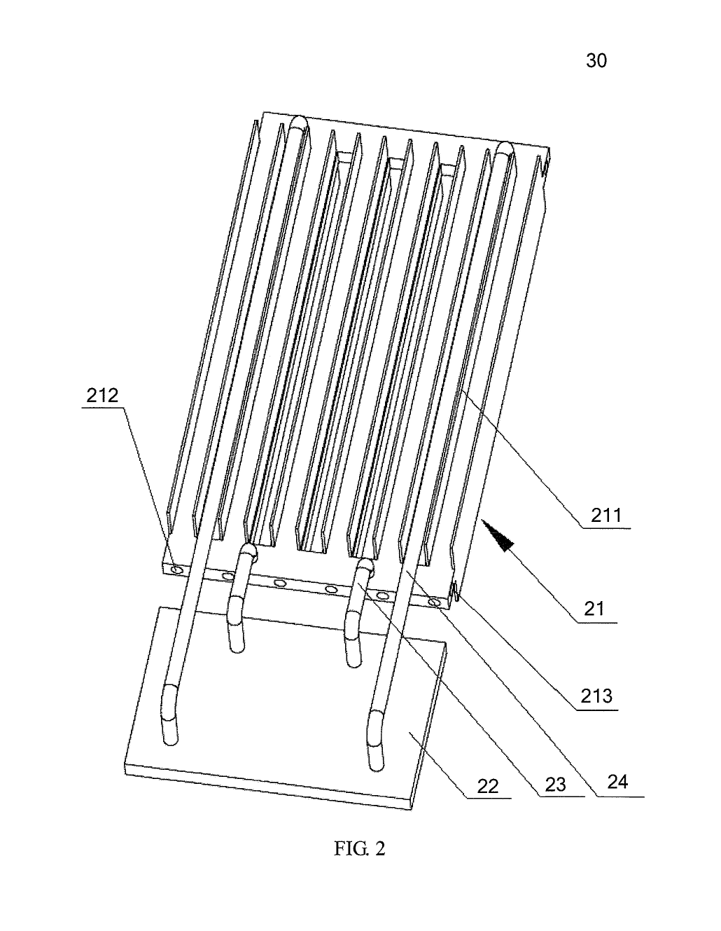

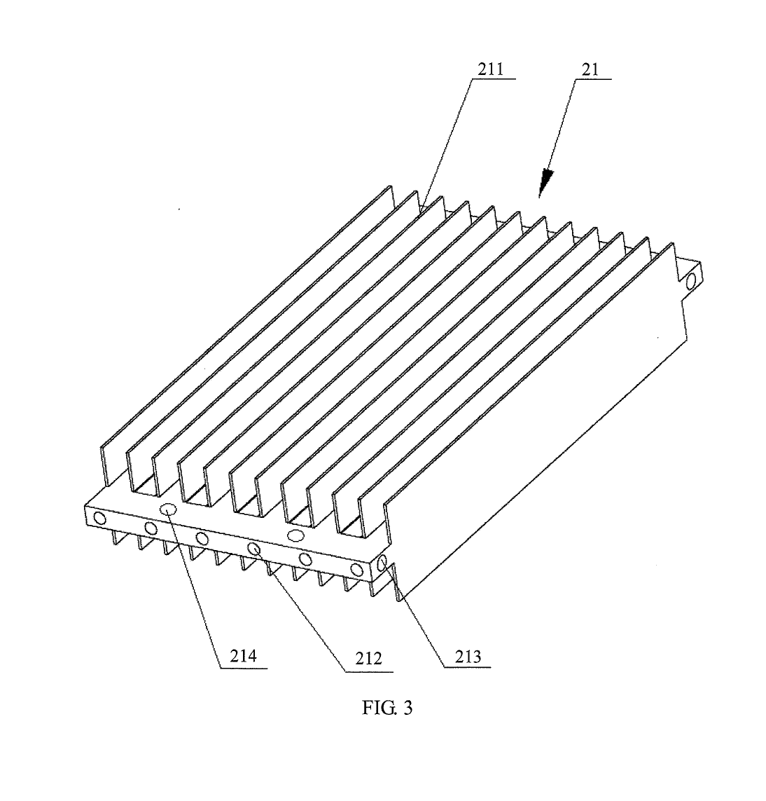

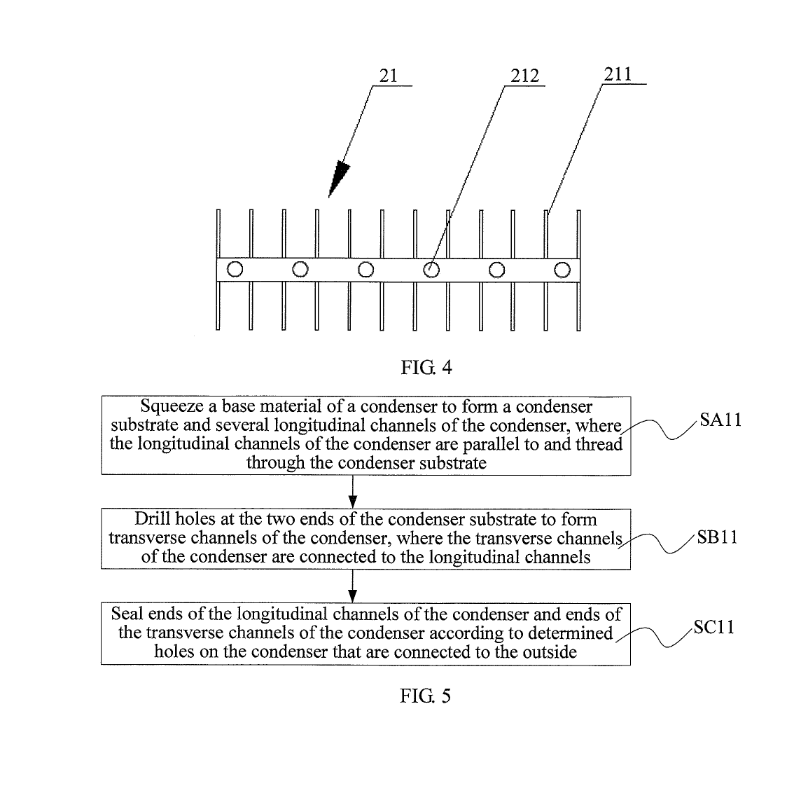

Refer to FIG. 2 to FIG. 4. FIG. 2 is a schematic structural diagram of a gravity loop heat pipe heat sink according to a specific embodiment of the present invention; FIG. 3 is a schematic structural diagram of a condenser shown in FIG. 2; and FIG. 4 is a side view of the condenser shown in FIG. 3.

In this embodiment, the heat sink includes a condenser 21 and an evaporator 22. It may be seen from FIG. 2 that, the condenser 21 has transverse channels 213 at an upper end and a lower end (as viewed from an angle shown in FIG. 2) of the condenser and longitudinal channels 212 of the condenser in the part between the upper end and the lower end of the condenser. The transverse channel 213 at the upper end is a vapor gathering pipeline, and the longitudinal channel 213 at the lower end is a liquid gathering pipeline. Vapor flows through a vapor rising pipeline 23 to the transverse channel 213 of the condenser at the upper end of the condenser 21, flows downward through the part between the upper end and the lower end of longitudinal channels 212 of the condenser, enters the transverse channel 213 of the condenser at the lower end of the condenser 21 after exchanging heat and condensing into a liquid state, and then flows back to the evaporator 22. Different from the prior art, the transverse channels 213 of the condenser 21 and the longitudinal channels 212 of the condenser are integrated. The transverse channels 213 of the condenser and the longitudinal channels 212 of the condenser shown in FIG. 2 are formed on a same substrate.

Refer to FIG. 5. FIG. 5 is a flowchart of a method for producing a condenser in a gravity loop heat pipe heat sink according to a specific embodiment of the present invention.

For the method for producing the condenser 21 of this structure, reference may be made to the following steps:

SA11) Squeeze a base material of the condenser to form several parallel longitudinal channels 212 of the condenser.

The base material of the condenser may be a metal material, such as aluminum, aluminum alloy, copper, or magnesium alloy. The base material of the condenser is placed into a die, and pressurized under a high temperature according to an existing squeezing technology to form a substrate of the condenser and several longitudinal channels 212 of the condenser, where the longitudinal channels 212 of the condenser thread through the condenser substrate. Using an azimuth shown in FIG. 2 as an example, the longitudinal channels 212 of the condenser thread through an upper end and a lower end of the condenser substrate. Generally, there are three or more longitudinal channels 212 of the condenser so as to ensure the condensation efficiency of vapor.

SB11) Drill holes at the two ends of the condenser substrate to form transverse channels 213 of the condenser, where the transverse channels 213 of the condenser are connected to the longitudinal channels 212 of the condenser.

The transverse channels 213 of the condenser are perpendicular to the longitudinal channels 212 of the condenser. When they are perpendicular to each other, each longitudinal channel 212 of the condenser has a same length and a same vapor circulation path, with heat evenly exchanged. Certainly, considering a deviation during drilling, the transverse channels 213 of the condenser may be roughly perpendicular to the longitudinal channels 212 of the condenser.

SC11) Seal ends of the longitudinal channels 212 of the condenser and ends of the transverse channels 213 of the condenser according to determined holes on the condenser 21 that are connected to the outside.

In the process of forming the longitudinal channels 212 of the condenser and the transverse channels 213 of the condenser, all these channels thread through the substrate. That is, the two ends of each of the longitudinal channels 212 of the condenser and the two ends of each of the transverse channels 213 of the condenser are connected to the outside. The transverse channels 213 of the condenser and the longitudinal channels 212 of the condenser serve as passageways of vapor or liquid, and except for a vapor inlet and a liquid outlet (which are two holes connected to the outside), the transverse channels 213 of the condenser and the longitudinal channels 212 of the condenser should be sealed cavities. Therefore, the ends of the transverse channels 213 of the condenser and the ends of the longitudinal channels 212 of the condenser need to be sealed.

In the sealing process, when it is determined that the vapor inlet and the liquid outlet are arranged at the ends of the transverse channels 213 of the condenser, the two ends of each longitudinal channel 212 of the condenser maybe sealed, with the two ends of each of the transverse channel 213 at the upper end of the condenser serving as vapor inlets, and the two ends of each of the transverse channel 213 at the lower end of the condenser serving as liquid outlets; or one end of each of the two transverse channels 213 of the condenser is sealed, and the other end respectively serves as the vapor inlet and the liquid outlet, in which case a vapor rising pipeline 23 and a liquid return pipeline 24 need to be located on two sides of the substrate. Alternatively, when it is determined that both the vapor inlet and the liquid outlet are arranged on the transverse channels 213 of the condenser, the two ends of each of the transverse channels 213 of the condenser may be sealed while some of the longitudinal channels 212 of the condenser are sealed, so that the ends (which are also located on the transverse channels 213 of the condenser) of the unsealed longitudinal channels 212 of the condenser serve as vapor inlets or liquid outlets to meet a requirement. The ends of the longitudinal channels 212 of the condenser or the ends of the transverse channels 213 of the condenser may be sealed in a welding manner. As shown in FIG. 2, all the ends of the longitudinal channels 212 of the condenser and all the ends of the transverse channels 213 of the condenser are sealed. It should be noted that, the preceding steps are actually not subject to a sequence limitation. Certainly, the sealing of the longitudinal channels 212 of the condenser is performed surely after the squeezing process, and the step of sealing the transverse channels 213 of the condenser is performed surely after the drilling process.

In the method for producing a condenser 21 in a heat sink according to this embodiment, a condenser substrate and a longitudinal channel 212 of the condenser on the condenser substrate are formed by using a squeezing technology, and a transverse channel 213 of the condenser is formed by using a drilling method on the substrate. That is, the longitudinal channel 212 of the condenser and the transverse channel 213 of the condenser are formed on the substrate by using the squeezing and drilling methods. In this way, the longitudinal channel 212 of the condenser and the transverse channel 213 of the condenser are integrated and do not need to be connected in a welding manner. Therefore, no welding joints exist between the longitudinal channel 212 and the transverse channel 213 of the condenser formed by using this production method, so that sealing performance, strength, or the like, of the condenser 21 can be ensured and the condenser 21 formed by using this production method has relatively high operating reliability.

A method for manufacturing the evaporator 22 in the heat sink in this embodiment is similar to the method for manufacturing the condenser 21, and may include the following steps:

Step 1: Squeeze a base material of the evaporator to form an evaporator substrate and several longitudinal channels of the evaporator, where the longitudinal channels of the evaporator are parallel to and thread through the evaporator substrate.

Similarly, the base material used for manufacturing the evaporator 22 may be a metal material, such as aluminum, aluminum alloy, copper, or magnesium alloy. The base material is squeezed under a high temperature in a die to form the substrate of the evaporator and the longitudinal channels of the evaporator, where the longitudinal channels of the evaporator thread through the substrate. The evaporator 22 is mainly configured to contact a heat source. Therefore, the evaporator 22 after the manufacturing should preferably appear to be a plate, so that there is a largest area of contact between the evaporator 22 and the heat source, thereby improving the heat transfer efficiency of the heat source and further improving heat dissipation performance.

Step 2: Drill holes at the two ends of the evaporator substrate to form transverse channels of the evaporator (two transverse channels of the evaporator respectively serve as a vapor gathering pipeline and a liquid gathering pipeline), where the transverse channels of the evaporator are connected to the longitudinal channels of the evaporator.

Similarly, the transverse channels of the evaporator are perpendicular to the longitudinal channels of the evaporator.

Step 3: Seal ends of the longitudinal channels of the evaporator and ends of the transverse channels of the evaporator according to determined holes on the evaporator that are connected to the outside.

Similarly, there are multiple manners of sealing the longitudinal channels of the evaporator 22 and the transverse channels of the evaporator 22. The preceding steps should not be construed as a sequence limitation on the process, and no further details are provided herein. During drilling, a liquid filling hole may be made on a transverse channel of the evaporator 22 or the condenser 21 and configured to add a heat dissipation medium inside the heat sink.

After the condenser 21 and the evaporator 22 are manufactured, the evaporator 22 and the condenser 21 may be fixed by using tooling according to positions designed in advance, with the two ends of the vapor rising pipeline 23 respectively aligned with a vapor outlet of the evaporator 22 and a vapor inlet of the condenser 21, and the two ends of the liquid return pipeline 24 respectively aligned with a liquid inlet of the evaporator 22 and a liquid outlet of the condenser 21. The liquid return pipeline 24 and the vapor rising pipeline 23 are fixed by using the tooling. Then the evaporator 22 and the condenser 21 are welded with the vapor rising pipeline 23 and the liquid return pipeline 24 in a brazing welding manner or in another welding manner, so as to form the whole heat sink provided in this embodiment. Finally, the heat sink is vacuumized, a heat dissipation medium is added from the liquid filling hole, and the liquid filling hole is welded and sealed. Then the manufacturing of the heat sink is complete. Actually the ends of the made transverse channels 213 of the condenser, the longitudinal channels 212 of the condenser, the transverse channels of the evaporator, and the longitudinal channels of the evaporator may all serve as liquid filling holes. Therefore, separate drilling is not required to form a liquid filling hole. In this case, a liquid filling hole may be reserved during the sealing of the transverse channels and the longitudinal channels, and the liquid filing hole is welded after the heat dissipation medium is added.

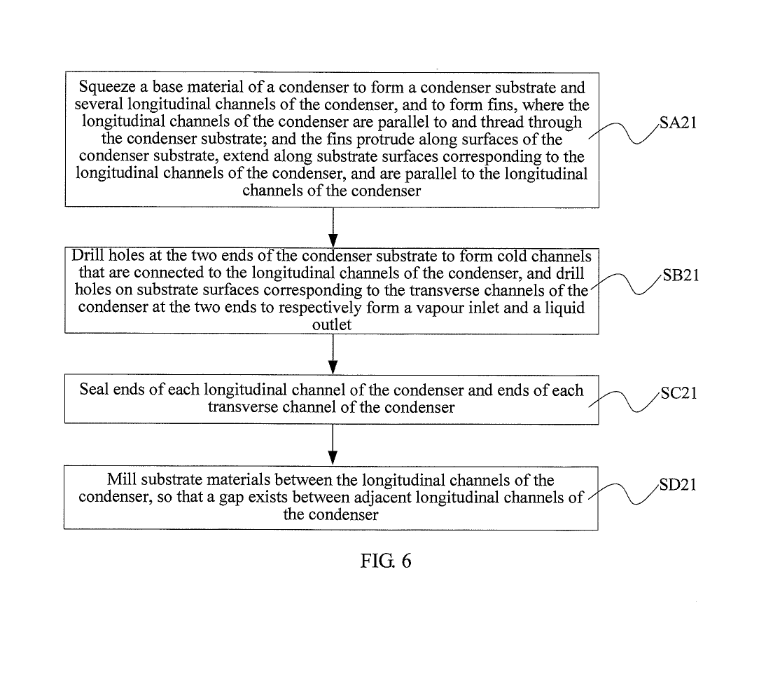

Refer to FIG. 6. FIG. 6 is a flowchart of a method for producing a condenser in a gravity loop heat pipe heat sink according to another specific embodiment of the present invention.

SA21) Squeeze a base material of a condenser to form a condenser substrate and several longitudinal channels 212 of the condenser, and to form fins 211, where the longitudinal channels 212 of the condenser are parallel to and thread through the condenser substrate; and the fins 211 protrude along a substrate surface of the condenser substrate, extend along substrate surfaces corresponding to the longitudinal channels 212 of the condenser, and are parallel to the longitudinal channels 212 of the condenser.

In this embodiment, compared with a first embodiment, when the substrate is formed by squeezing, the fins 211 may be simultaneously formed during the squeezing by improving the die. As shown in FIG. 4, there are the fins 211 on both the upper and the lower substrate surfaces (as viewed from an angle shown in FIG. 4) of the condenser 21. The fins 211 can enlarge an area of contact with air. That is, a heat exchange area is enlarged, so that vapor more quickly condenses into a liquid state. When the evaporator 22 is manufactured by using the same method, the fins may also be made by using this method.

SB21) Drill holes at the two ends of the condenser substrate to form transverse channels 213 of the condenser, where the transverse channels 213 of the condenser are connected to the longitudinal channels 212 of the condenser, and drill holes on substrate surfaces corresponding to the transverse channels 213 of the condenser at the two ends to respectively form a vapor inlet and a liquid outlet 214.

SC21) Seal ends of each longitudinal channel 212 of the condenser and ends of each transverse channel 213 of the condenser.

In combination with steps SB21 and SC21, it should be understood that after the two ends of each longitudinal channel 212 of the condenser and the two ends of each transverse channel 213 of the condenser are sealed, passageways of vapor and liquid are sealed cavities. In addition, holes are drilled on substrate surfaces corresponding to the transverse channels 213 of the condenser to form the vapor inlet and the liquid outlet 214 (As shown in FIG. 3, there are two second condenser openings, and the vapor inlet is not indicated in the figure but located on a substrate surface corresponding to the other transverse channel 213 of the condenser). Then a vapor rising pipeline 23 and a liquid return pipeline 24 may be arranged on a surface of the condenser substrate and located between two fins 211. Compared with arranging the vapor rising pipeline 23 and the liquid return pipeline 24 on two sides of the condenser 21, pipeline design based on such structure enables the structure of the heat sink to be more compact, prevents the vapor rising pipeline 23 and the liquid return pipeline 24 from interfering with other structures, and achieves more flexible installation. Accordingly, a corresponding vapor outlet and a corresponding liquid inlet may be made on substrate surfaces corresponding to the transverse channels of the evaporator.

SD21) Mill substrate materials between the longitudinal channels 212 of the condenser, so that a gap exists between adjacent longitudinal channels 212 of the condenser.

The substrate materials between the longitudinal channels 212 of the condenser may be milled in a machining manner. After the milling is performed, a certain gap exists between adjacent longitudinal channels 212 of the condenser. This method reduces the weight of the condenser 21, and thereby reduces the weight of the entire heat sink. In addition, the gap between adjacent longitudinal channels 212 of the condenser helps vapor inside a longitudinal channel 212 of the condenser to contact external air, and therefore further improves heat exchange efficiency. Certainly, the milling step may be performed before step SC21.

The foregoing detailed descriptions are about a gravity loop heat pipe heat sink, a condenser, and production methods thereof provided in the present invention. Specific cases are used for illustrating principles and implementation manners of the present invention. The foregoing description about the embodiments is merely for understanding the methods and core ideas of the present invention. It should be noted that a person of ordinary skill in the part may make certain improvements or polishing without departing from the principle of the present invention and such improvements or polishing should fall within the protection scope of the claims of the present invention.

What is claimed is:

1. A method for producing a condenser for a gravity loop heat pipe heat sink, the method comprising:
squeezing a base material of a condenser to form a condenser substrate and longitudinal channels of the condenser, wherein the longitudinal channels are parallel to and thread through the condenser substrate and configured to condense vapor;
drilling holes at the two ends of the condenser substrate to form transverse channels of the condenser that are connected to the longitudinal channels, wherein the transverse channels at the two ends respectively support circulation of vapor and liquid that is formed after vapor is condensed; and
sealing ends of the longitudinal channels and ends of the transverse channels according to determined holes on the condenser that are connected to the outside.

2. The method according to claim 1, wherein fins are further formed by squeezing; and the fins protrude along a substrate surface of the condenser substrate, extend along substrate surfaces corresponding to the longitudinal channels and are parallel to the longitudinal channels.

3. The method according to claim 2, wherein the fins are formed by squeezing surfaces on two sides of the condenser substrate.

4. The method according to claim 3, further comprising:
milling substrate materials between the longitudinal channels of the condenser, so that a gap exists between adjacent longitudinal channels of the condenser.

5. The method according to claim 1, further comprising: drilling holes on substrate surface corresponding to the transverse channels at the two ends to respectively form a vapor inlet and a liquid outlet; and
sealing ends of the transverse channels of the condenser and ends of each of the longitudinal channels.

6. The method according to claim 5, comprising drilling surrounding walls of the transverse channels of the condenser for circulating liquid to form a liquid filling hole.

7. A method for producing a gravity loop heat pipe heat sink, wherein the heat sink comprises a condenser and an evaporator connected to each other, and the method comprises a method for producing the condenser comprising:
squeezing a base material of a condenser to form a condenser substrate and longitudinal channels of the condenser, wherein the longitudinal channels are parallel to and thread through the condenser substrate and configured to condense vapor;
drilling holes at the two ends of the condenser substrate to form transverse channels of the condenser that are connected to the longitudinal channels, wherein the transverse channels at the two ends respectively support circulation of vapor and liquid that is formed after vapor is condensed; and
sealing ends of the longitudinal channels and ends of the transverse channels according to determined holes on the condenser that are connected to the outside.

8. The method according to claim 7, further comprising a method for producing the evaporator comprising:
squeezing a base material of the evaporator to form a evaporator substrate and several longitudinal channels of the evaporator, wherein the longitudinal channels of the evaporator are parallel to and thread through the evaporator substrate, and the longitudinal channels of the evaporator are configured to circulate vapor;
drilling holes at the two ends of the evaporator substrate to form transverse channels of the evaporator that are connected to the longitudinal channels of the evaporator, wherein the transverse channels of the evaporator at the two ends respectively support circulation of liquid and vapor that is formed after liquid is evaporated; and
sealing ends of the longitudinal channels of the evaporator and ends of the transverse channels of the evaporator according to determined holes on the evaporator that are connected to the outside.

9. The method according to claim 8, wherein:
fins are further formed by squeezing; and
the fins protrude along a substrate surface of the evaporator substrate, extend along substrate surfaces corresponding to the longitudinal channels of the evaporator, and are parallel to the longitudinal channels of the evaporator.

10. The method according to claim 8, further comprising:
drilling holes on substrate surface corresponding to the transverse channels of the evaporator at the two ends to respectively form a vapor outlet and a liquid inlet; and
sealing ends of the transverse channels of the evaporator and ends of each of the longitudinal channels of the evaporator.

11. A condenser for use in a gravity loop heat pipe heat sink, the condenser comprising:
longitudinal channels and transverse channels, the transverse channels of the condenser are located at two ends of the condenser, the longitudinal channels of the condenser and the transverse channels of the condenser are integrated, a substrate of the condenser and the longitudinal channels of the condenser are formed by squeezing a base material of the condenser, and the transverse channels of the condenser are formed by drilling holes at the two ends of the substrate of the condenser;
a vapor inlet and a liquid outlet disposed, respectively, on the transverse channels of the condenser at the two ends; and
wherein the longitudinal channels of the condenser and the transverse channels of the condenser are connected to the outside through the vapor inlet and the liquid outlet.

12. The condenser according to claim 11, further comprising:
fins formed by squeezing; and
wherein the fins protrude along a substrate surface of the condenser substrate, extend along substrate surfaces corresponding to the longitudinal channels of the condenser, and are parallel to the longitudinal channels of the condenser.

13. The condenser according to claim 11, wherein a gap formed by milling exists between adjacent longitudinal channels of the condenser.

14. The condenser according to claim 13, wherein the vapor inlet and the liquid outlet are formed by drilling holes on substrate surface corresponding to the transverse channels of the condenser.

15. A gravity loop heat pipe heat sink, comprising:
a condenser;
an evaporator;
wherein a transverse channel of the evaporator used for vapor circulation is connected to a transverse channel of the condenser used for vapor circulation through a vapor rising pipeline;
wherein a transverse channel of the condenser used for liquid circulation is connected to a transverse channel of the evaporator used for liquid circulation through a liquid dropping pipeline; and
the condenser comprises:
longitudinal channels and transverse channels, the transverse channels of the condenser are located at two ends of the condenser, the longitudinal channels of the condenser and the transverse channels of the condenser are integrated, a substrate of the condenser and the longitudinal channels of the condenser are formed by squeezing a base material of the condenser, and the transverse channels of the condenser are formed by drilling holes at the two ends of the substrate of the condenser,
a vapor inlet and a liquid outlet disposed, respectively, on the transverse channels of the condenser at the two ends, and
wherein the longitudinal channels of the condenser and the transverse channels of the condenser are connected to the outside through the vapor inlet and the liquid outlet.

16. The gravity loop heat pipe heat sink according to claim 15, wherein the condenser has fins formed by squeezing, and the fins protrude along a substrate surface of the condenser substrate, extend along substrate surfaces corresponding to the longitudinal channels of the condenser, and are parallel to the longitudinal channels of the condenser.

17. The gravity loop heat pipe heat sink according to claim 15, wherein a gap formed by milling exists between adjacent longitudinal channels of the condenser.

18. The gravity loop heat pipe heat sink according to claim 17, wherein the vapor inlet and the liquid outlet are formed by drilling holes on substrate surface corresponding to the transverse channels of the condenser.
